(19) United States
(12) Patent Application Publication
(10) Pub. No.: US 2024/0011870 A1
(43) Pub. Date: Jan. 11, 2024

(54) APPARATUS FOR TESTING AUTONOMOUS VEHICLE RESPONSES

(71) Applicant: TuSimple, Inc., San Diego, CA (US)

(72) Inventor: John E. PANTTILA, Tucson, AZ (US)

(21) Appl. No.: 18/218,072

(22) Filed: Jul. 4, 2023

Related U.S. Application Data
(60) Provisional application No. 63/358,775, filed on Jul. 6, 2022.

(51) Int. Cl. G01M 17/007

(52) U.S. Cl. CPC G01M 17/007

(57) ABSTRACT

An apparatus for testing autonomous vehicle responses is disclosed. The apparatus of an example embodiment comprises: a target object assembled from a plurality of panels, each panel having one or more attach points on an edge or surface of the panel, the attach points enabling removable attachment of the plurality of panels in a form representing the target object.

### PRIORITY PATENT APPLICATION

This non-provisional patent application draws priority from U.S. provisional patent application Ser. No. 63/358,775; filed Jul. 6, 2022. This present non-provisional patent application draws priority from the referenced patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2021-2023, TuSimple, Inc., All Rights Reserved.

### TECHNICAL FIELD

This patent document pertains generally to tools (systems, apparatuses, methodologies, computer program products, etc.) for autonomous vehicles, autonomous driving systems, autonomous vehicle testing, and more particularly, but not by way of limitation, to an apparatus for testing autonomous vehicle responses.

### BACKGROUND

Targets to test the ability of an autonomous vehicle to stop or maneuver appropriately are currently either real vehicles or inflatable structures. These types of targets have drawbacks including damage to the autonomous vehicle or target should the target be struck. Additionally, inflatables may have odd edges that may not be read by perception sensors appropriately, thus not providing a fair test of the system. Moreover, conventional test targets typically need to be fully replaced after a test with an autonomous vehicle. Replacing a struck test target is time and resource consuming.

### BRIEF DESCRIPTION OF THE DRAWINGS

The various embodiments are illustrated by way of example, and not by way of limitation, in the figures of the accompanying drawings in which:

FIG. 1 illustrates a side view of an apparatus for testing autonomous vehicle responses according to an example embodiment;

FIG. 2 illustrates a front view of an apparatus for testing autonomous vehicle responses according to an example embodiment; and

FIG. 3 illustrates a rear view of an apparatus for testing autonomous vehicle responses according to an example embodiment.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

An apparatus for testing autonomous vehicle responses is disclosed herein. When autonomous vehicles and autonomous driving systems are being designed and tested, it is imperative that these autonomous vehicles and systems react appropriately in a real world driving environment. However, autonomous vehicles cannot be released into a real world driving environment until they are fully tested and compliant with safety and efficacy requirements. As part of this testing of autonomous vehicles and autonomous driving systems, target objects can be used in a testing environment to assess the performance of autonomous vehicles, perception sensors, and autonomous driving systems when static or moving target objects are placed in proximity to the autonomous vehicle. Such test scenarios enable technicians to test the perception sensors on the autonomous vehicle to determine if the sensors effectively detect the presence of the target object. Additionally, technicians can also test the ability of the autonomous driving systems within the autonomous vehicle to use the sensor data and appropriately control the autonomous vehicle in view of the target object.

In an example embodiment, a target object, in the form of a target vehicle, can be implemented with the following characteristics:
1. The target object is constructed of rigid materials (e.g., aluminum sheets, polymer sheeting with honeycomb structure sandwiched between, metal sheeting with foam sandwiched between metal or vinyl layers, rigid foam sheets with or without laminate surfaces, or the like).
2. The rigid materials are formed into panels, which can be readily assembled into a target object prior to an autonomous test scenario.
3. The target object is easily reassembled after being struck by an autonomous vehicle in a test scenario.
4. Minimal damage is caused to the autonomous vehicle after the autonomous vehicle collides with a target object in a test scenario.
5. Minimal damage is caused to the target object after the autonomous vehicle collides with the target object in a test scenario.

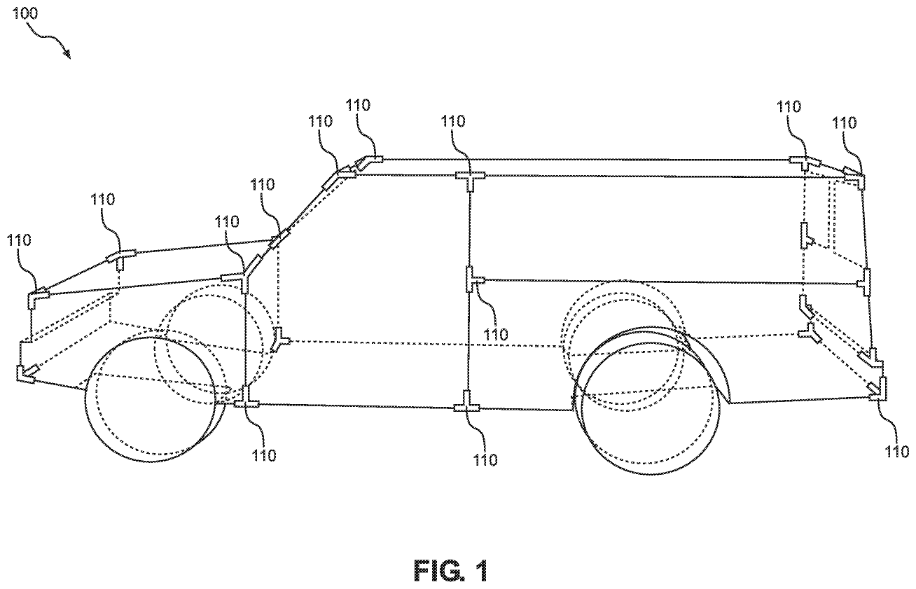

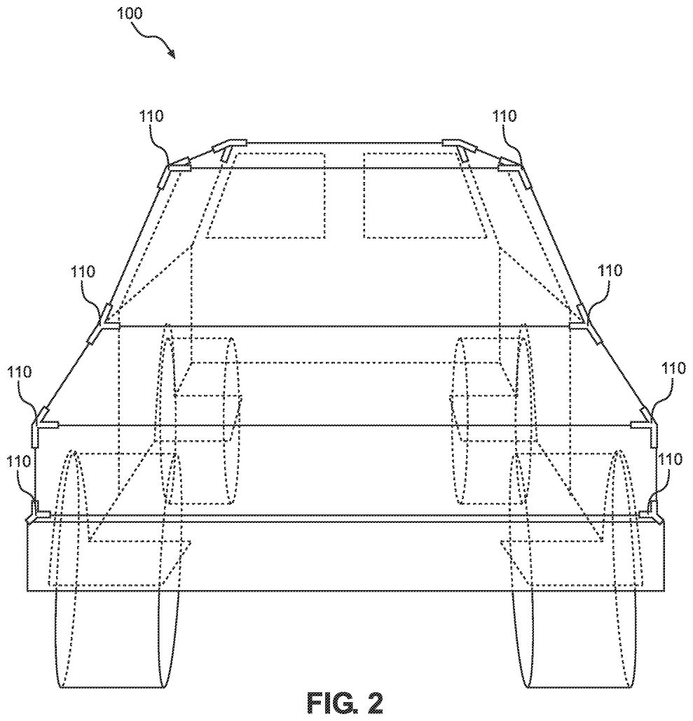

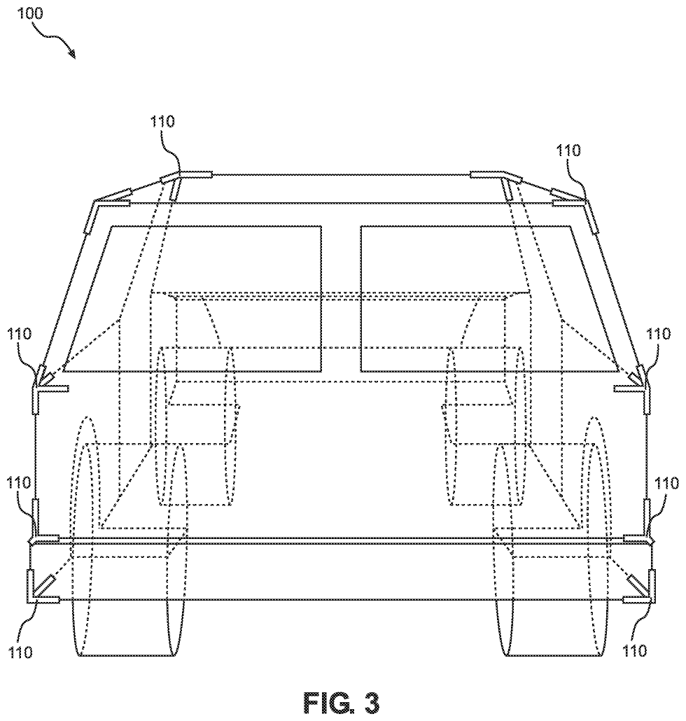

Referring now to FIGS. 1 through 3, FIG. 1 illustrates a side view of an apparatus 100 for testing autonomous vehicle responses according to an example embodiment. FIG. 2 illustrates a front view of an apparatus 100 for testing autonomous vehicle responses according to an example embodiment. FIG. 3 illustrates a rear view of an apparatus 100 for testing autonomous vehicle responses according to an example embodiment. In the example embodiments shown, a target object 100, in the form of a target vehicle, can be implemented as an assembled set of rigid (yet collapsible or yielding on impact) panels that can be removably attached at edges or surfaces of each panel. In the example embodiment, each panel can be attached to other panels at attach points 110 as shown in FIGS. 1 through 3. The attach points 110, enabling the panels to be removably attachable, can be implemented in several ways, such as hook and loop (Velcro™) strips, snaps, hooks, magnetic strips, or connection strips having a mild resealable adhesive applied thereto. As shown in FIGS. 1 through 3, the attach points 110 can be spaced along the edges or surfaces of each panel to securely, yet removably, connect the panels together in a desired shape. In the example embodiment shown, the set of panels for the target object 100 are assembled in the form of a target vehicle. However, in other embodiments, the set of panels for the target object 100 can be assembled in the form of other types of target objects, such as pedestrians, animals, inanimate objects, or the like.

In the example embodiments, the set of panels removably assembled to form the target object 100 can each be a rigid two inch thick (or other dimension) foam layer sandwiched between metal or vinyl outer layers. It will be apparent to those of ordinary skill in the art in view of the disclosure herein that a variety of different types of rigid materials can be used to construct the set of panels. Examples of these types of rigid materials are set forth above. The attach points 110 for each panel can be applied at various locations along the edges or surfaces of the panel. The outer surfaces of the panels can be colored, patterned, smooth, or textured, depending on the type of target object desired or the effect being modeled for a particular autonomous vehicle sensor system or control system. The target object 100 can be constructed with a plurality of panels with the attach points 110 implemented with hook and loop (Velcro™) strips, snaps, hooks, magnetic strips, or a mild resealable adhesive at the seams and/or edges of each panel so that the target object 100 readily breaks apart when struck by an autonomous vehicle. In an example embodiment, the attach points 110 can be variably resistive to separation, thereby requiring a variable level of force to break the attachment. In this manner, the target object 100 can retain its shape while being subjected to varying degrees of impact by the test autonomous vehicle. Because of the construction of the panels and attach points 110 of the target object 100 as disclosed herein, the collision between the target object 100 and the autonomous vehicle in a test scenario is unlikely to cause damage to either the target object 100 or the autonomous vehicle.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus for testing autonomous vehicle responses, the apparatus comprising:
a target object assembled from a plurality of panels, each panel having one or more attach points on an edge or surface of the panel, the attach points enabling removable attachment of the plurality of panels in a form representing the target object.

2. The apparatus of claim 1 wherein the target object is in the form of a test vehicle.

3. The apparatus of claim 1 wherein the target object is collapsible or yielding on impact by an autonomous vehicle.

4. The apparatus of claim 1 wherein the target object is easily reassembled after being struck by an autonomous vehicle in a test scenario.

5. The apparatus of claim 1 wherein minimal damage is caused to an autonomous vehicle after the autonomous vehicle collides with the target object in a test scenario.

6. The apparatus of claim 1 wherein the plurality of panels are of a type from a group consisting of: aluminum sheets, polymer sheeting with honeycomb structure sandwiched between, metal sheeting with foam sandwiched between metal or vinyl layers, and rigid foam sheets with or without laminate surfaces.

7. The apparatus of claim 1 wherein the plurality of panels are two inch thick rigid foam sheets with or without laminate surfaces.

8. The apparatus of claim 1 wherein the attach points are of a type from a group consisting of: hook and loop (Velcro™) strips, snaps, hooks, magnetic strips, and connection strips having a mild resealable adhesive applied thereto.

9. The apparatus of claim 1 wherein the attach points are variably resistive to separation.

10. The apparatus of claim 1 being configured to retain shape while being subjected to varying degrees of impact by a test autonomous vehicle.

11. An method for testing autonomous vehicle responses, the method comprising:
obtaining a plurality of panels forming a target object;
assembling the plurality of panels into the target object, each panel having one or more attach points on an edge or surface of the panel; and
removably attaching the plurality of panels at the attach points thereby enabling removable attachment of the plurality of panels in a form representing the target object.

12. The method of claim 11 wherein the target object is in the form of a test vehicle.

13. The method of claim 11 wherein the target object is collapsible or yielding on impact by an autonomous vehicle.

14. The method of claim 11 wherein the target object is easily reassembled after being struck by an autonomous vehicle in a test scenario.

15. The method of claim 11 wherein minimal damage is caused to an autonomous vehicle after the autonomous vehicle collides with the target object in a test scenario.

16. The method of claim 11 wherein the plurality of panels are of a type from a group consisting of: aluminum sheets, polymer sheeting with honeycomb structure sandwiched between, metal sheeting with foam sandwiched between metal or vinyl layers, and rigid foam sheets with or without laminate surfaces.

17. The method of claim 11 wherein the plurality of panels are two inch thick rigid foam sheets with or without laminate surfaces.

18. The method of claim 11 wherein the attach points are of a type from a group consisting of: hook and loop (Velcro™) strips, snaps, hooks, magnetic strips, and connection strips having a mild resealable adhesive applied thereto.

19. The method of claim 11 wherein the attach points are variably resistive to separation.

20. The method of claim 11 wherein the target object retains shape while being subjected to varying degrees of impact by a test autonomous vehicle.
